(19) United States
(12) Patent Application Publication
(10) Pub. No.: US 2010/0103208 A1
(43) Pub. Date: Apr. 29, 2010

(54) INK FILLING METHOD AND INKJET PRINTER

(75) Inventors: Keiichi ASAMI, Tokyo (JP); Taiki Yashima, Sagamihara (JP)

Correspondence Address: FRISHAUF, HOLTZ, GOODMAN & CHICK, P.C., 16th Floor, 220 Fifth Avenue, New York, NY, 10017-2023, US

(73) Assignee: Olympus Corporation, Tokyo (JP)

(21) Appl. No.: 12/603,024

(22) Filed: Oct. 21, 2009

(30) Foreign Application Priority Data
Oct. 28, 2008 (JP) 2008-276276
Sep. 15, 2009 (JP) 2009-213613

(51) Int. Cl. B41J 2/195

(52) U.S. Cl. 347/7

(57) ABSTRACT

An ink circulating unit is configured by including an ink head for spraying ink, a first tank, which is arranged upper than the ink head in a gravitational direction, for storing the ink to be supplied to the ink head, a second tank, which is arranged lower than the ink head in the gravitational direction, for storing the ink not sprayed from the ink head, and a pump for conveying the ink within the second tank to the first tank. A first step of driving the pump for a predetermined amount of time in a state where the first tank is sealed, and a second step of stopping the pump for a predetermined amount of time in a state where the air within the first tank is released are executed to fill the ink head with the ink.

### CROSS REFERENCE TO RELATED APPLICATION

This application is based upon and claims the benefit of priority from the prior Japanese Applications No. 2008-276276, filed Oct. 28, 2008, and No. 2009-213613, filed Sep. 15, 2009, the entire contents of which are incorporated herein by reference.

### BACKGROUND OF THE INVENTION

1. Field of the Invention

The present invention relates to an ink filling method for filling, with ink, an ink circulation path, which circulates the ink between an ink tank for storing the ink and an ink head for spraying the ink, and to an inkjet printer including the ink circulation path.

2. Description of the Related Art

Inkjet printers that spray ink onto a recording medium to record a desired image are conventionally known. Some of the inkjet printers include an ink circulation path. Patent Application Publication No. 2002-533247 discloses an initial ink filling method for filling an ink head with ink through such the ink circulation path.

The ink circulation path disclosed by Patent Application Publication No. 2002-533247 is configured as illustrated in FIGS. 1A and 1B. With the initial ink filling method disclosed by Patent Application Publication No. 2002-533247, a valve 5000 is provided at a first position 5002 illustrated in FIG. 1A, and an upper container 2040 is filled by driving a pump 2060. Next, a valve 3050 is closed, and a bypass valve 5012 and a valve 3060 are released. Then, the valve 3050 is released when ink flows into an ink head 2010. As a result, the ink head 2010 is filled with the ink.

As another initial ink filling method, the bypass valve 5012 is initially released. Next, the valve 3050 is closed, and at the same time, the valve 5000 is provided at a second position 5004 illustrated in FIG. 1B and connected to a bypass path 5020. Then, the pump 2060 is driven to pump up ink from a lower container 2050. As a result, the ink head 2010 is filled with the ink.

### SUMMARY OF THE INVENTION

An ink filing method according to the present invention for filling, with ink, an ink head of an inkjet printer having an ink circulating unit including the ink head for spraying the ink, a first tank, which is arranged upper than the ink head in a gravitational direction, for storing the ink to be supplied to the ink head, a second tank, which is arranged lower than the ink head in the gravitational direction, for storing the ink not sprayed by the ink head, and a pump for conveying the ink within the second tank to the first tank includes a first step of driving the pump for a predetermined amount of time in a state where the first tank is sealed, and a second step of stopping the pump for a predetermined amount of time in a state where the air within the first tank is released.

An inkjet printer according to the present invention comprises an ink circulating unit including an ink head having a nozzle plate on which a plurality of nozzles for spraying ink are formed, a first tank, which is arranged upper than the nozzle plate in a gravitational direction, for storing the ink to be supplied to the ink head, a first air release valve, which can be opened/closed, for making the first tank enter a sealed state or an air released state, a second tank, which is arranged lower than the nozzle plate in the gravitational direction, for storing the ink not sprayed from the ink head, and a pump for conveying the ink within the second tank to the first tank; and a controlling unit for controlling the opening/closing of the first air release valve and the driving of the pump when the ink head is initially filled with the ink. In the inkjet printer, the controlling unit repeatedly performs, by a plurality of times, a control for driving the pump for a predetermined amount of time in a state where the first air release valve is closed, and a control for stopping the pump for a predetermined amount of time in a state where the first air release valve is released.

### BRIEF DESCRIPTION OF THE DRAWINGS

FIGS. 1A and 1B illustrate an ink circulation path according to prior art;

FIG. 2 schematically illustrates a configuration of an ink path of an inkjet printer according to a first embodiment of the present invention;

FIG. 3 is an enlarged view schematically illustrating the configuration of an ink circulating unit of the inkjet printer according to the first embodiment;

FIGS. 4A, 4B and 4C are flowchart for explaining a process for filling the ink circulating unit of the inkjet printer according to the first embodiment with ink;

FIG. 5 is a flowchart illustrating a process executed when a supply valve is opened before a pump is driven in the process of FIG. 4;

FIG. 6 illustrates fluctuations in a pressure within ink heads when the process for filling the inkjet printer according to the first embodiment with the ink is executed;

FIG. 7 is a flowchart illustrating a process for circulating the ink within the ink circulating unit of the inkjet printer according to the first embodiment;

FIG. 8 is a flowchart illustrating a process for stopping the ink circulation of the ink circulating unit upon termination of printing of the inkjet printer according to the first embodiment;

FIG. 9 is a flowchart for explaining a first modification example of the process for filling the ink circulating unit in the first embodiment with ink;

FIG. 10 is a flowchart for explaining a second modification example of the process for filling the ink circulating unit in the first embodiment with ink;

FIG. 11 is a flowchart for explaining a third modification example of the process for filling the ink circulating unit in the first embodiment with ink;

FIG. 12 schematically illustrates a configuration of an ink path of the inkjet printer according to the third modification example of the first embodiment;

FIG. 13A illustrates an ink circulating unit in the second embodiment;

FIG. 13B is a flowchart illustrating a process for filling the ink circulating unit in the second embodiment with ink;

FIG. 14 illustrates an ink circulating unit in a third embodiment;

FIG. 15A illustrates an ink circulating unit in a fourth embodiment;

FIG. 15B is a flowchart illustrating a process for filling the ink circulating unit in the fourth embodiment with ink; and

FIG. 16 illustrates fluctuations in a pressure within the ink heads when the process for filling ink is executed in the fourth embodiment.

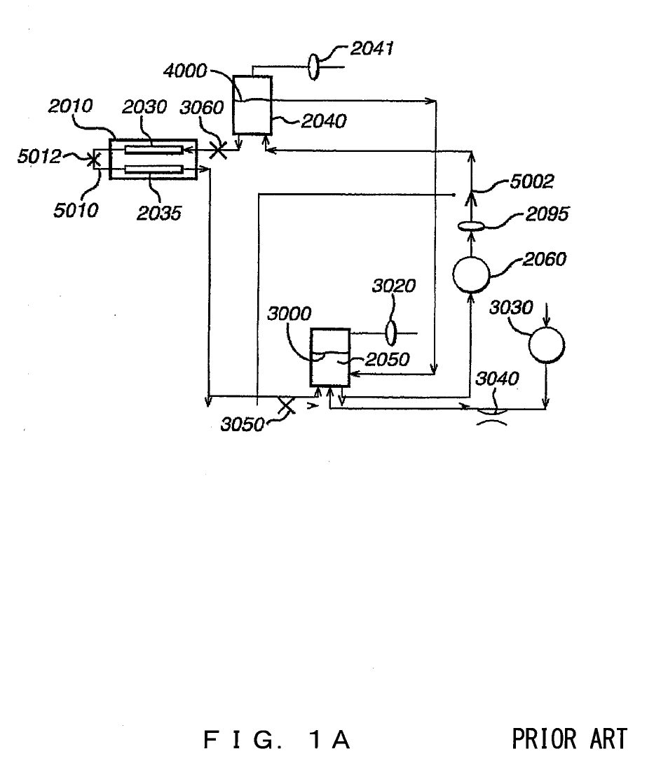

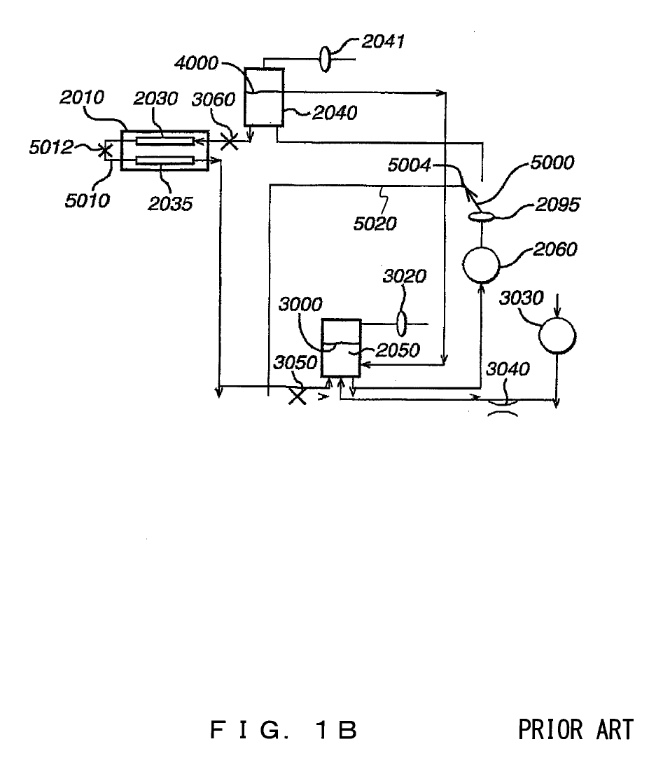

### DESCRIPTION OF THE PREFERRED EMBODIMENTS

Embodiments according to the present invention are described below with reference to the drawings.

### First Embodiment

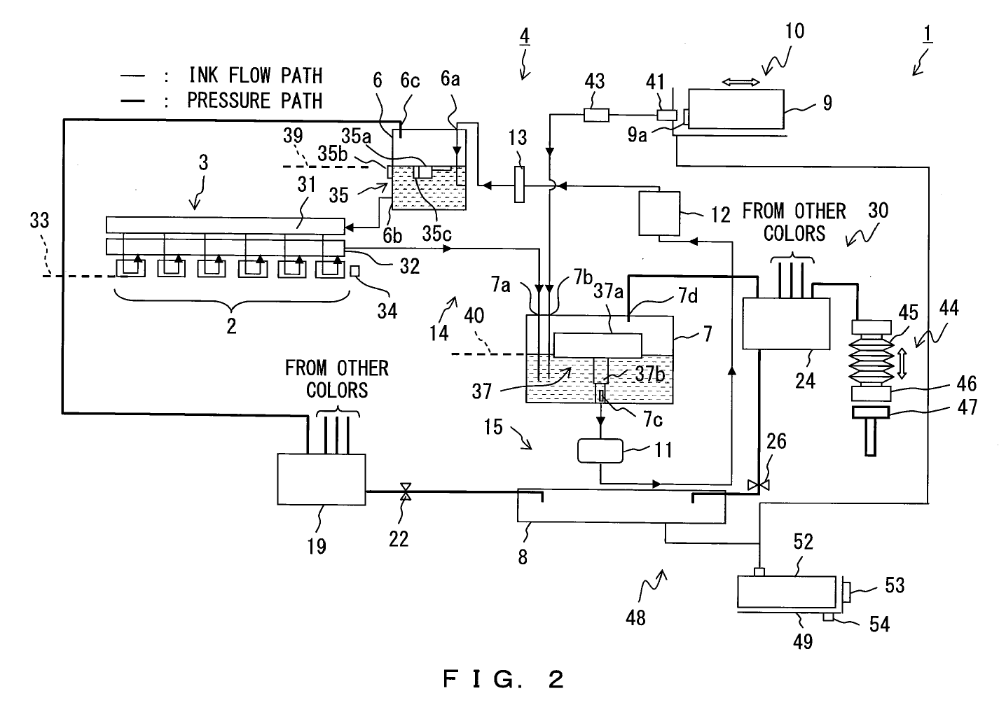

FIG. 2 schematically illustrates a configuration of an ink path of an inkjet printer according to a first embodiment of the present invention.

In FIG. 2, a supplying unit for supplying a recording medium, a conveying unit for conveying the supplied recoding medium, an ejecting unit for ejecting the recording medium on which an image is recorded, a cleaning unit for cleaning an ink head, a controlling unit for controlling the entire device, etc. are not illustrated.

The inkjet printer 1 illustrated in FIG. 2 records an image on the recording medium, for example, by using four ink colors such as cyan (C), magenta (M), yellow (Y), and black (K). FIG. 2 illustrates the configuration of the ink path for one ink color as a representative.

This inkjet printer 1 are mainly configured with an ink circulating unit 4, a filling unit 10 for filling the ink circulating unit 4 with ink, a liquid waste tank unit 48 for storing an unnecessary ink or an overflowing ink, and an upper tank air chamber 19 and a pressure adjusting unit 30, which are intended to adjust a pressure within the ink circulating unit 4.

The filling unit 10 is initially described.

The filling unit 10 has a joint unit 41 into/from which a supply port 9a of an ink cartridge 9 containing ink can be inserted/removed. By inserting the ink cartridge 9 into the joint unit 41, the ink within the ink cartridge 9 can be supplied to the ink circulating unit 4.

On an ink flow path connecting the filling unit 10 and the ink circulating unit 4, a supply valve 43 is provided. This supply valve 43 controls an ink supply to the ink circulating unit 4 by being opened/closed.

The ink circulating unit 4 is described next.

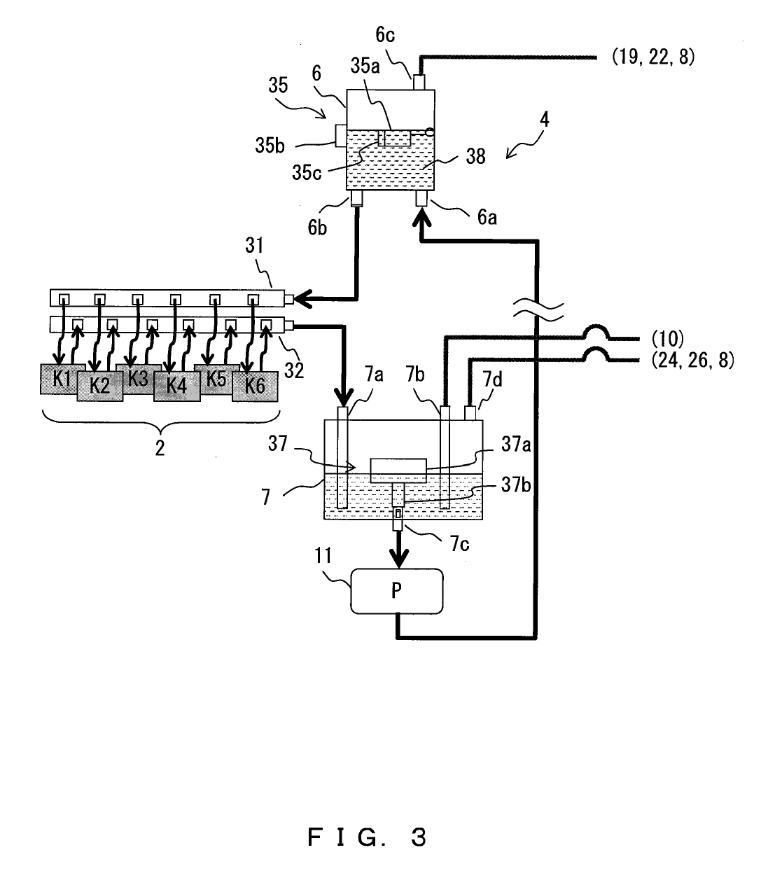

FIG. 3 is an enlarged view schematically illustrating the configuration of the ink circulating unit 4 of FIG. 2. In FIG. 3, the same components as those of FIG. 2 are denoted with the same reference numerals as those of FIG. 2. The configuration of the ink circulating unit 4 is described with reference to FIGS. 2 and 3.

The ink circulating unit 4 is mainly configured with an image recording unit 3, an upper tank 6 as a first tank, a lower tank 7 as a second tank, a pump 11, a heat exchanger 12, a filter 13, and tubes as ink flow paths, which connect the above described components (ink flow paths indicated by thin lines with an arrow in FIG. 3). The arrow indicates the flowing direction of the ink when the ink circulates within the ink circulating unit 4. In the ink circulating unit 4, the ink flows through the upper tank 6, the image recording unit 3, the lower tank 7, the pump 11, the heat exchanger 12, and the filter 13 in this order, and returns to the upper tank 6.

In the ink circulating unit 4 in this embodiment, the upper tank 6 is arranged upper than the image recording unit 3 in the gravitational direction. Additionally, the lower tank 7 is arranged lower than the image recording unit 3 in the gravitational direction. Furthermore, the ink circulating unit 4 in this embodiment can be broadly classified into a first ink path 14 and a second ink path 15.

The first ink path 14 is a path through which the ink flows from the upper tank 6 to the lower tank 7 via the image recording unit 3. The second ink path 15 is a path through which the ink is returned by the pump 11 from the lower tank 7 to the upper tank 6 via the heat exchanger 12 and the filter 13.

Configurations of components on the first ink path 14 are initially described in detail.

The image recording unit 3 includes a line head 2 for spraying ink, an ink distributor 31 for distributing the ink to the line head 2, and an ink collector 32 for collecting the ink not sprayed by the line head 2.

The line head 2 extends in a direction orthogonal to the conveyance direction of the recording medium, and has a width equal to or broader than a recording region of the recording medium.

The line head 2 in this embodiment is configured with six ink heads (K1 to K6). These ink heads (K1 to K6) are fixed to a frame, etc., for example, by being staggered in the width direction of a recording medium. Naturally, the number of ink heads is not limited to six. The number may be set to an arbitrary number.

The ink heads (K1 to K6) have a nozzle plate 33 on which nozzle holes (not illustrated) are formed. The ink heads (K1 to K6) record an image by spraying the ink onto the recording medium conveyed by a conveying unit not illustrated.

The ink distributor 31 is provided to evenly distribute the ink to the ink heads (K1 to K6) of the line head 2.

The ink collector 32 is provided to collect the ink not sprayed by the ink heads (K1 to K6) of the line head 2 at one site.

In the ink heads (K1 to K6) or their neighborhood, a temperature sensor 34 for detecting the temperature of the ink is arranged. This temperature sensor 34 is provided to control the heat exchanger 12.

The upper tank 6 is arranged upper than the image recording unit 3 in the gravitational direction. More specifically, the upper tank 6 is arranged so that an ink liquid surface 39 within the upper tank 6 is higher than the nozzle plate 33 of the ink heads (K1 to K6).

Additionally, an ink inlet port 6a, an ink outlet port 6b, and an air port 6c are provided in the upper tank 6. Moreover, a liquid surface detecting unit 35 for keeping the position of the ink liquid surface 39 at a predetermined height is provided in the upper tank 6.

The ink inlet port 6a is connected to the above described filter 13 on the side of the second ink path 15 via a tube. The ink that passes through the filter 13 flows into the upper tank 6 via the ink inlet port 6a.

The ink outlet port 6b is connected to the ink distributor 31 via a tube. The ink within the upper tank 6 flows into the ink distributor 31. The ink that flows into the ink distributor 31 is almost evenly distributed to the ink heads (K1 to K6).

Here, an amount of the ink that flows into the ink heads (K1 to K6) via the ink distributor 31 is set to exceed an amount of the ink sprayed from the ink heads (K1 to K6). Therefore, the ink not sprayed from the ink heads (K1 to K6) flows into the ink collector 32.

This ink collector 32 is connected to the lower tank 7 via a tube. Accordingly, the ink not sprayed from the ink heads (K1 to K6) flows into the lower tank 7 via the ink collector 32.

In this embodiment, the ink distributor 31 is provided. However, the upper tank 6 and the line head 2 (ink heads (K1 to K6)) may be directly connected. Also the ink collector 32 is provided in this embodiment. However, the lower tank 7 and the line head 2 (ink heads (K1 to K6)) may be directly connected.

The air port 6c is connected to the upper tank air chamber 19 via a tube. The upper tank air chamber 19 is connected to an overflow tank 8 of the liquid waste tank unit 48 to be described later by a tube provided with an air release valve 22 as a first air release valve.

The overflow tank 8 is always exposed to the air. Accordingly, the upper tank air chamber 19 is communicated with or blocked (sealed) from the air by opening/closing (releasing/blocking) the air release valve 22.

Namely, since the upper tank air chamber 19 is connected to the air port 6c via the tube, an air within the upper tank 6 can be released or sealed.

When the air within the upper tank 6 is released, the ink within the upper tank 6 flows into the ink distributor 31 due to a height difference of liquid surface (water head difference) between the upper tank 6 and the image recording unit 3. Moreover, when the upper tank 6 is sealed, the ink within the upper tank 6 does not flow into the ink distributor 31.

In this embodiment, also upper tanks of the other three colors are connected to the upper tank air chamber 19. Namely, the air within the upper tanks of all the colors can be simultaneously released or sealed by one upper tank air chamber 19.

As a matter of course, an air release valve may be provided for each upper tank of each of the colors without providing the upper tank air chamber 19. As a result, the releasing or the sealing of the air can be controlled for each upper tank of each of the colors.

The liquid surface detecting unit 35 includes a float member 35a, a liquid surface position sensor 35b, and a magnet 35c.

The float member 35a rises/falls according to the height of the liquid surface of the ink within the upper tank 6. To the float member 35a, the magnet 35c is attached.

The liquid surface position sensor 35b is configured with a magnetic sensor, and detects the magnet 35c attached to the float member 35a. As a result, the liquid surface position sensor 35b detects the position of the float member 35a, namely, the height of the liquid surface of the ink.

The liquid surface detecting unit 35 is not limited to the above described configuration. The liquid surface detecting unit 35 may be arbitrarily configured as far as it can detect the position of the ink liquid surface 39. For example, part of a wall surface of the upper tank 6 may be configured with a transparent member to directly detect the position of the liquid surface with a reflective optical sensor.

The lower tank 7 is arranged lower than the image recording unit 3 in the gravitational direction. More specifically, the lower tank 7 is arranged so that an ink liquid surface 40 within the lower tank 7 is positioned lower than the nozzle plate 33 of the ink heads (K1 to K6).

The lower tank 7 is provided with an ink inlet port 7a, an ink supply port 7b, an ink outlet port 7c, and an air port 7d. Within the lower tank 7, a liquid surface adjustor 37 is provided.

The ink inlet port 7a is connected to the ink collector 32 of the image recording unit 3 via a tube. Accordingly, the ink not sprayed from the line head 2 is once collected by the ink collector 32 and flows down into the lower tank 7.

The ink supply port 7b is connected to the filling unit 10 via a tube. If the amount of ink of the ink circulating unit 4 becomes smaller than a preset amount of ink, the ink is supplied from the ink cartridge 9 to the lower tank 7.

The ink outlet port 7c is connected to a pump 11 to be described later via a tube.

The air port 7d is connected to the pressure adjusting unit 30 via a tube. The pressure adjusting unit 30 is configured with a lower tank air chamber 24 and a negative pressure adjustment mechanism 44.

The lower tank air chamber 24 is connected to the overflow tank 8 by a tube provided with an air release valve 26 as a second air release valve. Accordingly, the lower tank air chamber 24 is communicated with or blocked (sealed) from the air by opening/closing (releasing/blocking) the air release valve 26.

Namely, since the lower tank air chamber 24 is connected to the air port 7d via the tube, an air within the lower tank 7 can be released or sealed. The negative pressure adjustment mechanism 44 is connected to the lower tank air chamber 24 via a tube. The negative pressure adjustment mechanism 44 is configured with a bellows unit 45 for generating a negative pressure, a weight unit 46, and a bellows raising/lowering unit 47.

The bellows unit 45 is connected to the lower tank air chamber 24 with a tube, and makes the lower tank air chamber 24 enter a negative pressure state by being stretched out.

This negative pressure initially releases the air release valve 26, and then releases the air within the lower tank air chamber 24. Next, the bellows unit 45 and the weight unit 46 are raised by the bellows raising/lowering unit 47. After raising the bellows unit 45 and the weight unit 46 to a predetermined position, the air release valve 26 is closed.

By closing the air release valve 26 in this way, the air within the lower tank 7 and the insides of the lower tank air chamber 24 and the bellows unit 45 result in an externally closed space while communicating with one another. If the bellows unit 45 is stretched out/contracted in this state, the volume of the closed space increases/decreases.

Namely, the bellows unit 45 is pulled downward by the weight of the weight unit 46 by lowering the bellows raising/lowering unit 47, and the volume of the closed space increases. As a result, a negative pressure the size of which matches the gravity applied to the weight unit 46 occurs within the lower tank air chamber 24.

The negative pressure occurring within the lower tank air chamber 24 applies the same negative pressure to the lower tank 7 communicated via the tube. The negative pressure state of the lower tank 7 also applies a predetermined negative pressure to the line head 2 communicated via the tube.

With the predetermined negative pressure, meniscus can be formed in the ink on the nozzles. Additionally, this predetermined negative pressure also contributes to the circulation of the ink. As described above, the negative pressure adjustment mechanism 44 forms meniscus by applying a negative pressure to the line head 2, whereby a proper printing operation is enabled.

In this embodiment, also lower tanks of the other three colors are connected to the lower tank air chamber 24. Namely, one negative pressure adjustment mechanism 44 can simultaneously change the pressures within the lower tanks 7 of all the colors to an equal pressure. Naturally, the negative pressure may be adjusted for each lower tank of each of the colors without providing the lower tank air chamber 24.

The liquid surface adjustor 37 is configured with a float member 37a, and an extending member 37b extending downward from the float member 37a. The liquid surface adjustor 37 moves according to the ups and downs of the ink surface.

Additionally, the liquid surface adjustor 37 self-adjusts the amount of ink pumped up by the pump 11 into the upper tank 6 according to the height of the ink surface of the lower tank 7.

More specifically, the float member 37a falls with a drop in the position of the ink surface within the lower tank 7. As a result, the extending member 37b blocks an opening of the ink outlet port 7c. Namely, the ink within the lower tank 7 is not supplied to the pump 11 any more.

Furthermore, the float member 37a rises with a rise in the position of the ink liquid surface of the lower tank 7. As a result, the extending member 37b exposes the opening of the ink outlet port 7c. Namely, the ink within the lower tank 7 is supplied to the pump 11.

By repeating these operations, the ink liquid surface 40 within the lower tank 7 can be maintained within a desired range. The ink within the lower tank 7 is conveyed to the upper tank 6 through the second ink path 15.

The liquid surface adjustor 37 in this embodiment slides along the ink outlet port 7c to block/expose the opening of the ink outlet port 7c according to the height of the ink liquid surface.

Next, configurations of components on the second ink path 15 are described in detail.

The pump 11 is connected to the ink outlet port 7c of the lower tank 7 via a tube. The pump 11 conveys the ink within the lower tank 7 to the upper tank 6.

In this embodiment, the pump 11 is designed to enable a larger amount of ink than the amount of ink flowing down into the lower tank 7 to be conveyed to the upper tank 6. Accordingly, in this embodiment, the pump 11 is implemented with a gear pump that can convey a fixed amount of ink regardless of the viscosity of the ink.

However, the pump 11 is not limited to the gear pump. Any pump is available as the pump 11 as far as it can convey a larger amount of ink than the amount ink flowing down into the lower tank 7 as described above. For example, a diaphragm pump, a piston pump, a tube pump, a rotary pump, or a volute pump is available.

By conveying a larger amount of ink than the amount of ink flowing down into the lower tank 7 as described above, the lower tank 7 can be prevented from overflowing. Namely, the ink does not overflow from the lower tank 7 by making the amount of ink conveyed by the pump 11 larger than the amount of ink flowing down into the lower tank 7 in a normal use state.

In this embodiment, the liquid surface adjustor 37 is provided at the ink outlet port 7c of the lower tank 7 as described above. Accordingly, a fixed pressure valve (not illustrated) is provided in the pump 11 so that the internal pressure between the ink outlet port 7c and the pump 11 does not become a preset value or more.

This valve is provided to protect a suction force, which is higher than the maximum buoyancy of the liquid surface adjustor 37, from being applied to the ink outlet port 7c. Namely, the liquid surface adjustor 37 is prevented from sucking and clinging to the ink outlet port 7c with the suction force of the pump 11 even though the ink liquid surface 40 rises.

Under the pump 11, the liquid waste tank unit 48 is arranged. The liquid waste tank unit 48 is configured with a tank tray 49, a liquid waste tank 52, a waste ink amount detecting unit 53, a tank installation detecting unit 54, and the overflow tank 8.

The overflow tank 8 is configured in the form of a tray, and arranged under the pump 11. Accordingly, even if the pump 11 is broken and the ink leaks out, the overflow tank 8 can store the whole of the leaking ink.

Additionally, the overflow tank 8 is connected to the upper tank air chamber 19 and the lower tank air chamber 24. Accordingly, even if the ink overflows from the upper tank 6 or the lower tank 7 due to a fault of the device, the leaking ink can be stored in the overflow tank 8.

The overflow tank 8 is connected to the liquid waste tank 52 via a tube. The liquid waste tank 52 is arranged on the tank tray 49 to be attachable/detachable to/from the tank tray 49.

The tank tray 49 is provided with the waste ink amount detecting unit 53 for detecting the amount of ink stored in the liquid waste tank 52, and the tank installation detecting unit 54 for detecting whether or not the liquid waste tank 52 is installed with weight detection or optical detection.

When a predetermined amount of waste ink is stored in the liquid waste tank 52, the waste ink amount detecting unit 53 detects this and notifies a user to replace the tank.

Additionally, the liquid waste tank 52 is connected to the filling unit 10 via a tube. Therefore, the ink that externally leaks when the ink cartridge 9 is replaced flows into the liquid waste tank 52 as a liquid waste via the tube.

The heat exchanger 12 is connected to the pump 11 via a tube. The heat exchanger 12 adjusts the ink conveyed by the pump 11 to fall within a predetermined temperature range. Namely, the heat exchanger 12 heats or cools down the flowing ink on the basis of the above described temperature sensor 34.

The filter 13 is connected to the heat exchanger 12 via a tube. The filter 13 removes foreign substances contained in the ink supplied to the line head 2.

Thus configured ink circulating unit 4 releases the air release valve 22 to release the air within the upper tank 6 at the time of image recording (ink circulation). At the same time, the ink circulating unit 4 closes the air release valve 26 to set the pressure within the lower tank 7 to a predetermined negative pressure with the pressure adjusting unit 30.

As a result, spherically concave meniscus is formed in the nozzle holes of each of the ink heads of the line head 2, whereby a proper printing operation is enabled.

Additionally, when the inkjet printer 1 is in a standby state (when the ink is not circulated), the air release valve 22 is closed to block the inside of the upper tank 6 from the air. At the same time, the air release valve 26 is opened to release the air within the lower tank 7.

At this time, meniscus is formed by a height difference in the nozzle holes of the line head 2 because the lower tank 7 is arranged lower than the line head 2 in the gravitational direction as described above. Namely, the ink does not drip from the line head 2 in the standby state.

The above description refers to the operations performed by assuming the state where the ink circulating unit 4 is already filled with the ink. Actually, however, in the initial state of the inkjet printer 1 (for example, when a user uses the inkjet printer 1 for the first time), the ink circulating unit 4 is required to be filled with ink because it is not filled with the ink.

A process for filling the ink circulating unit 4 with ink is described below.

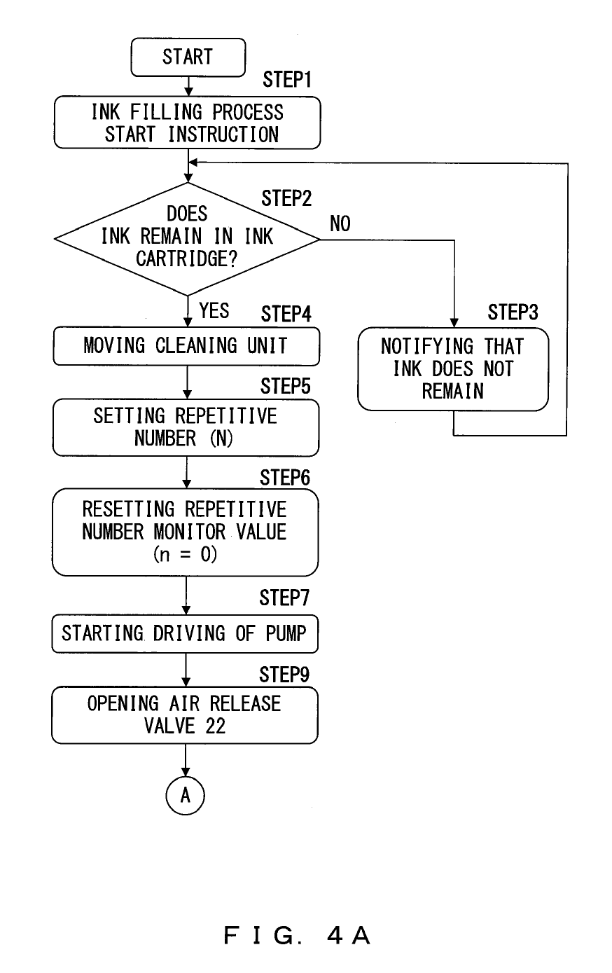

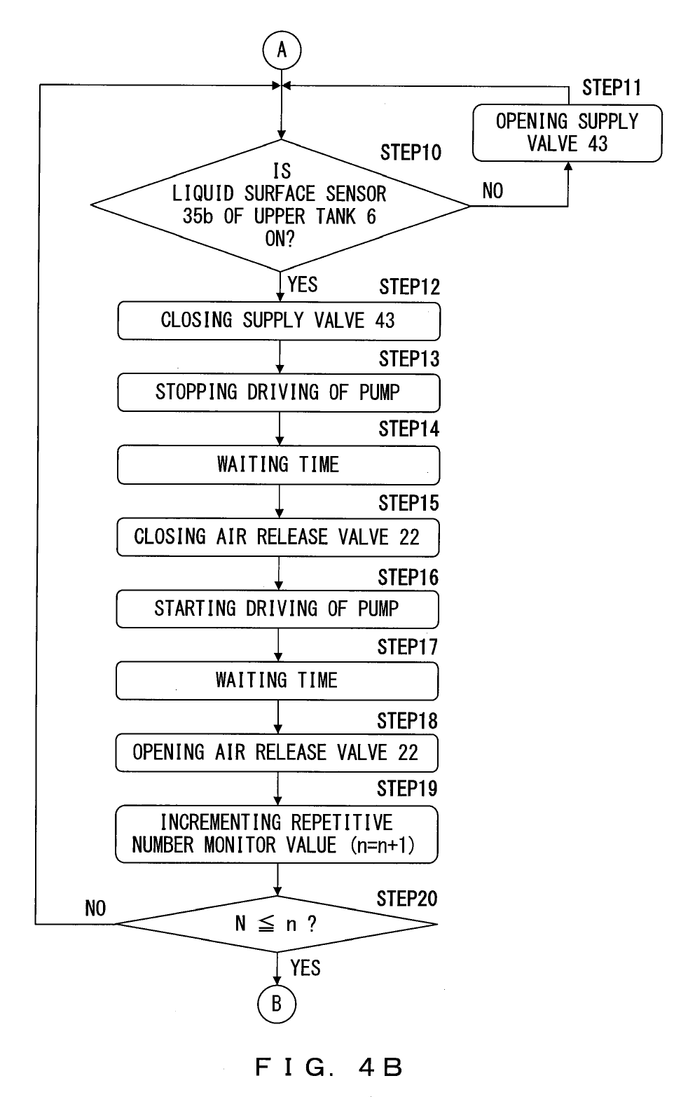

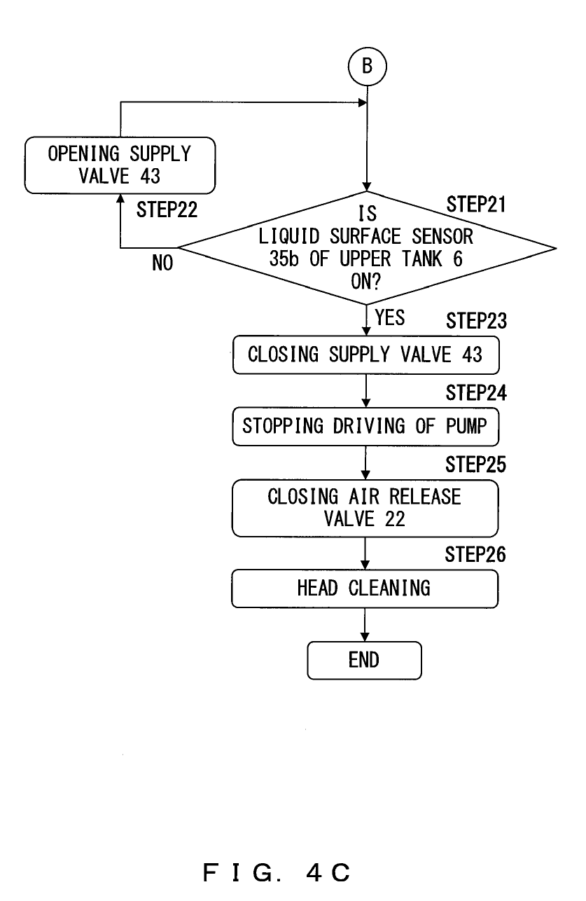

FIG. 4 is a flowchart for explaining a process for filling all the ink heads (K1 to K6), namely, the ink circulating unit 4 in this embodiment with ink. The initial state of the ink circulating unit 4 immediately before this process is started is as follows.

The air release valve 22 is closed. The air release valve 26 is open. The pump 11 stops. The supply valve 43 is closed. The bellows unit 45 is contracted by the bellows raising/lowering unit 47 to the topmost position that is the standby position. The process for filling the ink circulating unit 4 with the ink is executed in this state.

In FIG. 4, the ink filling process starts to be executed (STEP 1).

In this process, ink filling process start instruction is initially issued with manual operations performed by a user or a maintenance staff who maintains the inkjet printer on an operation panel not illustrated. Next, it is necessary to verify whether or not the amount of ink required for the ink filling process for the ink circulating unit 4 is sufficient in the ink cartridge 9. Therefore, whether or not a sufficient amount of ink remains in the ink cartridge 9 is determined (STEP 2).

In this process, whether or not the amount of ink remaining in the ink cartridge 9 is sufficient for the amount required for the ink filling process is determined by a remaining amount detecting unit not illustrated.

If it is determined that the amount of ink within the ink cartridge 9 does not remain or is insufficient (“NO” in STEP 2), it is notified that the amount of ink does not remain (STEP 3). Then, the flow goes back to STEP 2.

In the process of STEP 3, it is notified to the user or the maintenance staff with the operation panel not illustrated or another notification function that the ink cartridge should be replaced.

In contrast, if the amount of ink within the ink cartridge 9 is sufficient (“YES” in STEP 2), the cleaning unit not illustrated is moved to the position facing the line head 2 (STEP 4).

This process is intended to collect the ink dripping from the ink heads (K1 to K6) when the ink filling process is performed. Namely, this process is executed to prevent the inside of the printer from becoming dirty by the ink dripping from the ink heads (K1 to K6).

Then, a repetitive number N of operations performed between STEP 13 and STEP 18 for executing the head filling process is set to an arbitrary value (STEP 5).

In this embodiment, the repetitive number N is set to 6 (N=6). However, the number N may be set to a number suitable for the head filling process according to the configuration (the length and the arrangement) of the ink circulating unit 4.

Next, a monitor value n of the repetitive number is reset to 0 (STEP 6).

This process is a process for setting, to the initial value “n=0”, the monitor value n for counting the number of times that the operations between STEP 13 and STEP 18 are performed. As described above, the operations performed in STEP 1 to STEP 6 are an initial process of the ink filling process.

Then, the pump 11 starts to be driven (STEP 7), and the air release valve 22 is opened (STEP 9).

As a result, the inside of the upper tank 6 becomes the atmospheric pressure via the upper tank air chamber 19. If the ink circulating unit 4 is filled with the ink, a positive pressure according to the height difference between the ink liquid surface 39 of the upper tank 6 and the nozzle plate 33 is applied to the ink heads (K1 to K6).

Next, whether or not the liquid surface position sensor 35b of the upper tank 6 is ON (the state where a predetermined amount of ink is stored) is determined (STEP 10).

As in this embodiment, the initial state of the ink circulating unit 4 is an empty state where the ink circulating unit 4 is not filled with the ink. Therefore, the liquid surface sensor 35b of the upper tank 6 is OFF (the state where the predetermined amount of ink is not stored). Namely, the determination made in STEP 10 results in “NO”. Then, the supply valve 43 is opened (STEP 11), and an operation for supplying the ink to the lower tank 7 is started.

When the operation for supplying the ink to the lower tank 7 is started, the ink liquid surface 40 of the lower tank 7 rises. At the same time, the liquid surface adjustor 37 rises with a rise in the ink liquid surface 40. As a result, the ink within the lower tank 7 is conveyed to the upper tank 6 by the pump 11.

When the ink is conveyed to the upper tank 6, the ink liquid surface 39 within the upper tank 6 rises. Also the float member 35a rises with a rise in the ink liquid surface 39.

When the amount of ink within the upper tank 6 increases to a predetermined amount and the liquid surface sensor 35b of the upper tank 6 is turned on (“YES” in STEP 10), the supply valve 43 is closed (STEP 12). As described above, the operations of STEP 7 to STEP 12 are a supplying process for the amount of ink within the upper tank 6 to be a predetermined amount.

If it is a problem that the pump 11 is driven in the ink empty state, a process for opening the supply valve 43 may be executed before the pump 11 is driven.

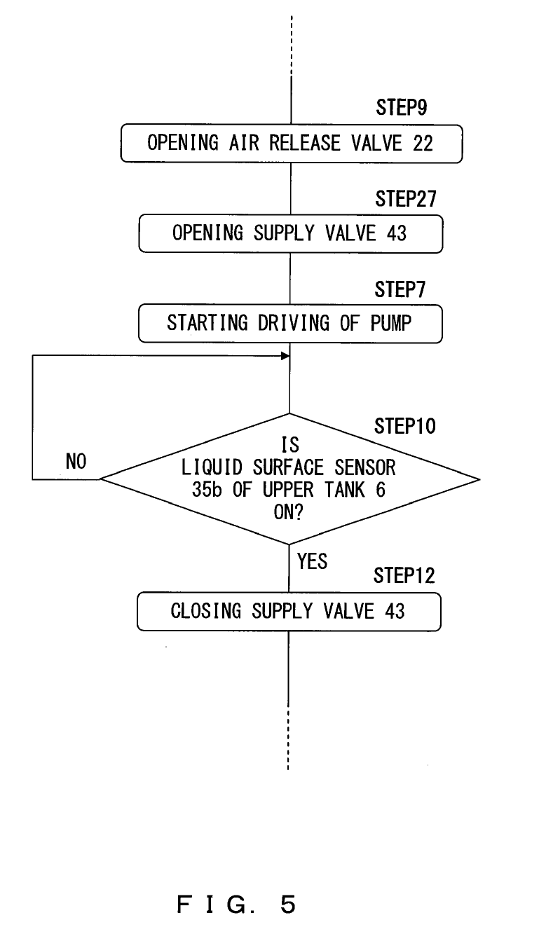

FIG. 5 is a flowchart illustrating the process for opening the supply valve 43 before the pump 11 is driven. In the process illustrated in FIG. 5, the inside of the upper tank 6 becomes the atmospheric pressure by initially opening the air release valve 22 (STEP 9) subsequent to the process of STEP 6 in FIG. 4.

Next, the ink is supplied to the lower tank 7 by opening the supply valve 43 (STEP 27). Thereafter, the pump 11 starts to be driven (STEP 7).

Then, whether or not the liquid surface position sensor 35b of the upper tank 6 is ON is determined (STEP 10). When the liquid surface position sensor 35b of the upper tank 6 is turned on, the supply valve 34 is closed (STEP 12). The supplying process may be executed in this way.

Referring back to FIG. 4. Upon termination of the supplying process for the upper tank 6 as described above, a head filling process for the ink heads (K1 to K6) is executed in STEP 13 to STEP 18.

Initially, the driving of the pump 11 is stopped (STEP 13). After stopping the operations of the pump 11, an elapse of a predetermined amount of time is waited (STEP 14).

In this waiting process, the air release valve 22 is open. Therefore, the upper tank 6 is communicated with the air via the upper tank air chamber 19. Moreover, since the air release valve 26 is open, the lower tank 7 is communicated with the air via the lower tank air chamber 24.

Accordingly, the ink within the upper tank 6 passes through the upper tank 6 and the ink heads (K1 to K6) due to gravity (water head difference), and flows down into the lower tank 7.

As a result, the ink within the upper tank 6 decreases, whereas the ink within the lower tank 7 increases. At this time, the amount of ink flowing down into the lower tank 7 becomes maximum when the ink circulating unit 4 is properly filled with the ink. Accordingly, the above described waiting time is set to a time during which the lower tank 7 does not overflow and the ink of the upper tank 6 does not become empty even when the flowing amount of ink becomes maximum.

For example, if the capacity required until the lower tank overflows is 30 ml (a remaining capacity obtained by subtracting a minimum amount of ink required when the liquid surface adjustor 37 blocks the flow path from the total allowable capacity), and the capacity of the ink within the upper tank 6 (the capacity of ink within the upper tank 6 in the state where the liquid surface sensor 35b is ON) is 40 ml when the maximum amount of ink of 5 ml/sec per color flows down, the time during which the ink within the upper tank 6 does not become empty and the lower tank 7 does not overflow results in a time shorter than 6 seconds.

Accordingly, the waiting time is set to, for example, 4 seconds in this embodiment. This prevents the lower tank 7 from overflowing, and also prevents the ink within the upper tank 6 from becoming empty, which prevents the air from flowing into the first path 14.

Additionally, the waiting time in STEP 14 may be set according to the temperature of the ink.

By way of example, for ink the viscosity of which significantly varies with a temperature change, also the amount of ink flowing down per unit time varies. Therefore, the temperature of the ink is detected with temperature detecting means (for example, the temperature sensor 34), and the waiting time is calculated based on the temperature. As a result, the amount of ink flowing down into the lower tank 7 can be stabilized regardless of the temperature of the ink.

Here, the ink within the upper tank 6 flows down into the lower tank 7 after passing through the ink heads (K1 to K6) due to gravity (water head difference) by waiting for the elapse of the predetermined amount of time in the state where the operations of the pump 11 are stopped and the air release valve 22 is released as described above.

At this time, for example, if the line head 2 is configured by arranging the plurality of ink heads (K1 to K6) per color as in this embodiment, there are a plurality of ink paths connecting the ink distributor 31 and the plurality of ink heads (K1 to K6).

In such a case, the ink starts to enter all the ink paths not simultaneously but with time lags. As a result, an ink path that is not filled with the ink occurs, and an ink path on which air bubbles remain occurs.

More specifically, on an ink path that is completely filled with the ink, the ink is easy to flow since a load imposed on the flow of the ink is light. In contrast, on the ink path that is not filled with the ink or the ink path on which air bubbles remain, the ink is difficult to flow since the load imposed on the flow of the ink becomes heavier than the ink path that is completely filled with the ink.

Accordingly, even if the ink is made to flow from the upper tank 6 to the lower tank 7 by gravity (water head difference), the ink tends to flow into the ink path that is completely filled with the ink. As a result, it becomes difficult to completely fill, with the ink, the ink path that is not filled with the ink and the ink path on which air bubble remain.

Additionally, if the ink is only made to flow from the upper tank 6 to the lower tank 7 by gravity (water head difference) even when one ink head is used unlike this embodiment using the plurality of ink heads (K1 to K6) per color, it is difficult to completely remove air bubbles within the ink head.

As described above, the ink head cannot be completely filled with the ink only by making the ink flow from the upper tank 6 to the lower tank 7 by gravity (water head difference) regardless of the number of ink heads.

Accordingly, the air release valve 22 is closed subsequent to the above described waiting process (STEP 15).

As a result, the upper tank 6 is blocked from the air via the upper tank air chamber 19. Namely, the ink within the upper tank 6 does not flow down into the lower tank 7.

Next, the driving of the pump 11 is restarted (STEP 16).

As a result, the ink within the lower tank 7 is pumped up into the upper tank 6 at a stroke except for a minimum amount of ink required by the liquid surface adjustor 37 that blocks the opening of the ink outlet port 7c.

At this time, the upper tank 6 is blocked from the air because the air release valve 22 is closed. Accordingly, the pressure within the upper tank 6 rapidly increases according to the volume of the ink pumped up from the lower tank 7.

As a result, the amount of ink conveyed from the upper tank 6 to the ink heads (K1 to K6) rapidly increases. In consequence, the ink heads (K1 to K6) that cannot be filled with the ink only by making the ink flow from the upper tank 6 to the lower tank 7 with gravity (water head difference) can be filled with the ink.

By applying a pressure to the upper tank 6 as described above, the air unevenly remaining in the ink heads (K1 to K6) is pushed out into the lower tank 7. Then, all the ink heads (K1 to K6) are filled with the ink.

Then, an elapse of a predetermined amount of time is waited (STEP 17).

In this waiting process, a time (waiting time) during which the pump 11 is driven in the state where the air release valve 22 is closed is waited.

Here, the pressure within the upper tank 6 gradually decreases with the elapse of time because the ink flows out of the upper tank 6. Namely, also the force of pushing out the air bubbles remaining in the ink heads (K1 to K6) reduces.

Accordingly, the waiting time is set to a time during which the air bubbles remaining in the ink heads (K1 to K6) can be efficiently pushed out. In other words, the waiting time is set to the time required until the pressure within the upper tank 6 drops to a predetermined value. In this embodiment, the waiting time is set to approximately 10 seconds. Similar to STEP 14, an optimum waiting time may be calculated according to the temperature of the ink.

After the waiting time elapses, the air release valve 22 is again opened (STEP 18).

As a result, the upper tank 6 is again communicated with the air.

Then, the monitor value n is incremented by 1, namely, n=n+1 is set (STEP 19).

In this way, the repetitive number of the head filling process is counted.

Then, whether or not the monitor value n is equal to or larger than the repetitive number N, namely, whether or not N≧n is determined (STEP 20).

If the monitor value n is smaller than the repetitive number N (“NO” in STEP 20), the flow goes back to STEP 10. Then, the head filling process is repeated.

As described above, in the head filling process, the ink heads (K1 to K6) can be securely filled with the ink by combining the step (second step) of waiting for the predetermined amount of time in the state where the pump 11 is stopped and the air within the upper tank 6 is released, and the step (first step) of waiting for the predetermined amount of time in the state where the pump 11 is driven and the upper tank 6 is sealed.

In the head filling process illustrated in FIG. 4, the step (first step) of waiting for the predetermined amount of time in the state where the pump 11 is driven and the upper tank 6 is sealed is executed after the step (second step) of waiting for the predetermined amount of time in the state where the pump 11 is stopped and the air within the upper tank 6 is released.

However, the step (second step) of waiting for the predetermined amount of time in the state where the pump 11 is stopped and the air within the upper tank 6 is released may be executed after the step (first step) of waiting for the predetermined amount of time in the state where the pump 11 is driven and the upper tank 6 is sealed.

If the determination made in STEP 20 results in “YES”, whether or not the liquid surface position sensor 35b of the upper tank 6 is ON is determined (STEP 21).

If the liquid surface position sensor 35b of the upper tank 6 is OFF (“NO” in STEP 21), the supply valve 43 is opened (STEP 22). Then, the supply valve 43 is closed when the liquid surface position sensor 35b is turned on (STEP 23). Then, the driving of the pump 11 is stopped (STEP 24).

When the amount of ink within the upper tank 6 reaches the predetermined amount, the supply valve 43 is closed to stop the ink supply to the lower tank 7 as described above. Moreover, the pump 11 is stopped to suspend the ink supply to the upper tank 6.

Then, the air release valve 22 is closed (STEP 25).

By closing the air release valve 22, the upper tank 6 is blocked from the air. As a result, the ink within the upper tank 6 does not flow down into the lower tank 7.

Then, head cleaning is made (STEP 26).

In this process, the ink is adhered to the nozzle plate 33 of the ink heads (K1 to K6) as a result of the ink filling process. Accordingly, the nozzle plate 33 of the ink heads (K1 to K6) is cleaned with the cleaning unit not illustrated.

After being cleaned, meniscus is formed in the nozzle holes. Here, the ink filling process is terminated.

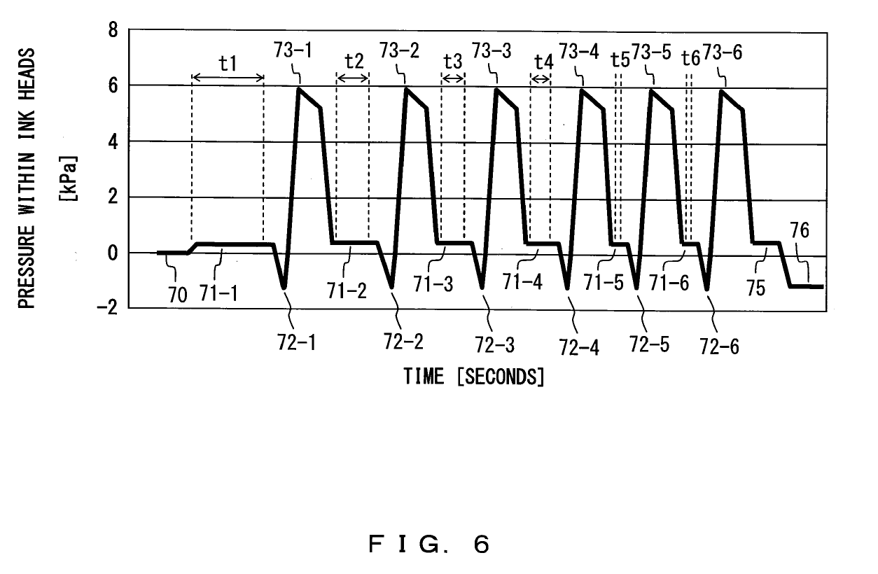

FIG. 6 illustrates fluctuations in the pressure within the ink heads (K1 to K6) when the ink filling process in this embodiment is executed. In this figure, the horizontal and the vertical axes represent time (seconds) and the pressure within the ink heads (K1 to K6), respectively.

FIG. 6 is described in comparison with the above described steps of FIG. 4.

When STEP 1 to STEP 9 are executed, the ink heads (K1 to K6) are communicated with the air since there is no ink within them. Accordingly, the internal pressure of the ink heads (K1 to K6) is approximately 0 kPa (gage pressure) like a waveform 70.

In STEP 10 to STEP 12, the ink is conveyed to the ink circulating unit 4, and also flows down into the ink heads (K1 to K6).

At this time, a lot of air remains in the ink heads (K1 to K6). However, the nozzle holes are blocked by the ink that flows down into the ink heads (K1 to K6), the insides of which are then blocked from the air.

Accordingly, the internal pressure of the ink heads (K1 to K6) results in a slightly positive pressure (pressure slightly higher than the atmospheric pressure) of approximately +0.5 kPa like waveforms 71-1 to 71-6 due to the height difference between the ink heads (K1 to K6) and the upper tank 6.

Also in STEP 13 and STEP 14, the ink flows down from the upper tank 6 into the lower tank 7 via the ink heads (K1 to K6) because the pump 11 is stopped. The pressure applied by the height difference is similarly exerted during this period. Therefore, the internal pressure of the ink heads (K1 to K6) is approximately +0.5 kPa.

Here, the reason why similar waveforms are generated six times is that the repetitive number N is set to 6 (STEP 5), and the head filling process is executed six times in this embodiment.

Additionally, the reason why intervals t1 to t6 of the waveforms 71-1 to 71-6 become narrower as the monitor value n increases is that the ink circulating unit 4 is gradually filled with the ink each time the repetitive number is incremented, and the ink filling time in STEP 10 to STEP 12 is reduced.

When STEP 15 is executed, the upper tank 6 is blocked from the air, and the ink does not flow down from the upper tank 6 into the lower tank 7.

Then, the internal pressure of the ink heads (K1 to K6) results in a slightly negative pressure (pressure slightly lower than the atmospheric pressure) of approximately −1.0 kPa for a short time like waveforms 72-1 to 72-6 due to the height difference between the ink heads (K1 to K6) and the lower tank 7.

Next, when STEP 16 and STEP 17 are executed, the ink that flows down into the lower tank 7 with the processes of STEP 13 and STEP 14 is pumped up into the upper tank 6 by the pump 11 at a stroke.

Accordingly, the internal pressure of the upper tank 6 blocked from the air rapidly rises, and shapes waveforms 73-1 to 73-6. The internal pressure of the ink heads (K1 to K6) at this time is approximately +6 kPa.

As a result of the influence exerted by this pressure, the velocity of flow of the ink that flows through the first ink path 14 becomes faster. Therefore, air bubbles remaining on the first ink path 14 are externally pushed out of the nozzle holes, or pushed away into the lower tank 7 that is communicated with the air.

In this embodiment, the repetitive number is set to 6. Therefore, the waveforms of approximately +6 kPa, which are resultant from the rapidly applied pressure, occur six times.

While STEP 18 to STEP 20 are being executed, the internal pressure of the ink heads (K1 to K6) results in approximately +0.5 kPa like the waveforms 71-1 to 71-6 in a similar manner as in STEP 12 and STEP 13.

Upon completion of a desired repetitive number, STEP 21 to STEP 24 are executed. Also at this time, the internal pressure of the ink heads (K1 to K6) is approximately +0.5 kPa like a waveform 75.

When STEP 25 is executed, the internal pressure of the ink heads (K1 to K6) results in a slightly negative pressure (pressure slightly lower than the atmospheric pressure) of approximately −1.0 kPa like a waveform 76 due to the height difference between the ink heads (K1 to K6) and the lower tank 7. This is because the inside of the lower tank 7 is the atmospheric pressure from scratch.

In this state, the head cleaning for removing droplets of the nozzle plate 33 is made (STEP 26), and the ink filling process is complete.

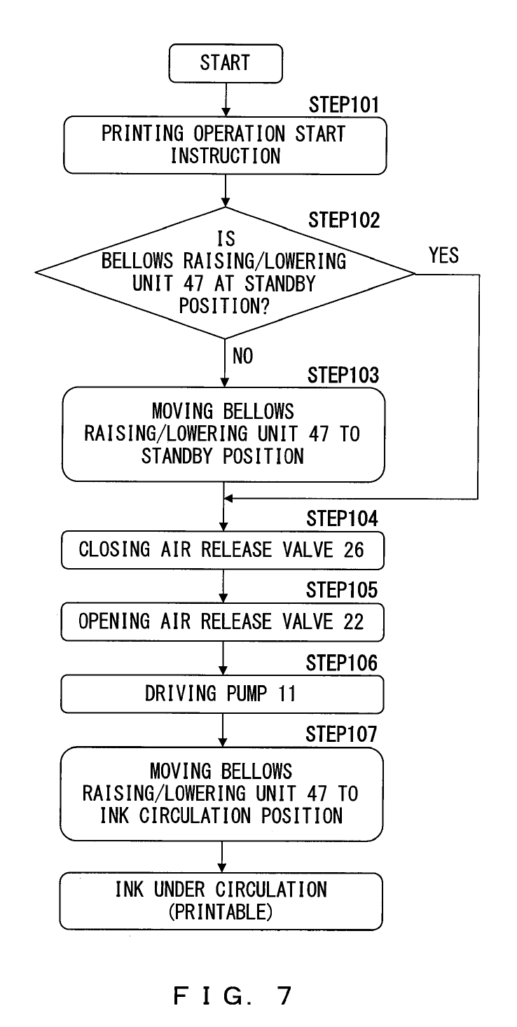

FIG. 7 is a flowchart illustrating a process for circulating the ink within the ink circulating unit 4. The ink circulation process executed when a printing operation is performed is described with reference to FIG. 7.

Assume that the ink circulating unit 4 is already filled with the ink with the ink filling process described with reference to FIG. 4 or 5. Namely, meniscus is formed in the nozzle holes of all the ink heads (K1 to K6).

In FIG. 7, a printing operation start instruction is initially issued (STEP 101).

In this process, a printing instruction is issued to the inkjet printer via an interface with the outside.

As a result, the following process is executed for the ink circulating unit 4 to shift from the standby state to a printable state.

Initially, whether or not the bellows raising/lowering unit 47 is at the standby position is verified (STEP 102). The position of the bellows raising/lowering unit 47 is detected by a position sensor not illustrated. This process is a process for determining whether or not the bellows unit 45 is contracted to the uppermost position by the bellows raising/lowering unit 47.

If the bellows raising/lowering unit 47 is determined to be at the standby position (“YES” in STEP 102), the flow goes to STEP 104. If the bellows raising/lowering unit 47 is determined not to be at the standby position (“NO” in STEP 102), the flow goes to STEP 104 after the bellows raising/lowering unit 47 is moved to the upper standby position (STEP 103).

The bellows raising/lowering unit 47 moves to the standby position as described above, whereby the negative pressure of the lower tank 7 is ready to be generated.

Next, the air release valve 26 is closed (STEP 104). As a result, the lower tank 7 is blocked from the air.

Then, the air release valve 22 is opened (STEP 105). As a result, the upper tank 6 is communicated with the air.

Next, the operations of the pump 11 are started (STEP 106). Then, the bellows raising/lowering unit 47 is moved to a circulation position (STEP 107). The circulation position is a position that is lower than the standby position in the gravitational direction, and also a position at which the weight unit 46 is not supported by the bellows raising/lowering unit 47 even if the bellows unit 45 is stretched out by the weight of the weight unit 46.

Namely, in this process, the bottom of the bellows unit 45 is freely released by lowering the bellows raising/lowering unit 47. As a result, the bellows unit 45 is stretched downward by the weight of the weight unit 46, and the negative pressure is applied to the lower tank 7 (line head).

The above described processes of STEP 104 to STEP 107 are executed almost simultaneously or successively in a short time. This is intended to suppress fluctuations in the internal pressure of the upper tank 6 or the lower tank 7 when the ink within the ink circulating unit 4 shifts from the static state (standby state) to the dynamic state (circulation state).

With the above described four steps from STEP 104 to STEP 107, the upper tank 6 is communicated with the air, the lower tank 7 is blocked from the air, and at the same time, the negative pressure is generated by the pressure adjusting unit 30.

As a result, the negative pressure suitable for the printing operation is applied to the ink heads (K1 to K6), and the ink circulating unit 4 enters the printable ink circulation state.

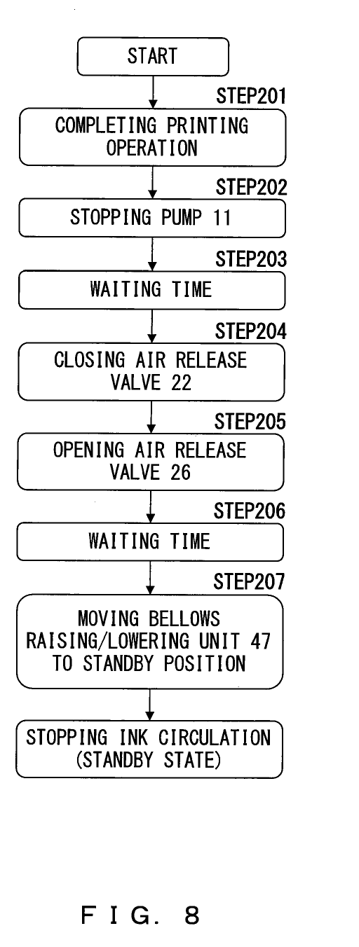

FIG. 8 is a flowchart illustrating a process for stopping the ink circulation within the ink circulating unit 4 upon termination of the printing operation. The ink circulation stopping process executed upon termination of the printing operation is described with reference to FIG. 8.

Initially, in a printing operation completion process (STEP 201), an instruction to stop the ink circulation of the ink circulating unit 4 is issued to the inkjet printer upon completion of printing directed by the printing operation start instruction.

When the ink circulation stop instruction is issued, the pump 11 is stopped (STEP 202).

Then, a predetermined amount of time is waited from the stoppage of the pump 11 (STEP 203).

Here, if the waiting time is set to a short time, the air release valve 22 can be possibly closed in the state where the pump 11 is not completely stopped due to the inertia.

In such a case, the pressure within the upper tank 6 rises, which can possibly damage meniscus formed in the nozzle holes of the ink heads (K1 to K6).

In contrast, if the waiting time is set to a long time, the ink within the upper tank 6 flows down into the lower tank 7. Therefore, the amount of ink within the upper tank 6 is reduced, which can possibly mix air bubbles in the ink heads (K1 to K6).

Accordingly, the above described waiting time is set to 1.5 seconds in this embodiment where the waiting time is set in consideration of the time from when the instruction to stop the operations of the pump 11 is issued until when the pump 11 actually stops, and the amount of ink within the upper tank 6. Note that there is no need to provide the waiting time depending on the performance of the pump 11.

Then, the air release valve 22 is closed (STEP 204). As a result, the upper tank 6 is blocked from the air.

Next, the air release valve 26 is opened (STEP 205). As a result, the lower tank 7 is communicated with the air. The above described processes of STEP 203 to STEP 205 are executed almost simultaneously or successively in a short time.

Subsequently, a predetermined amount of time is waited (STEP 206), and the bellows raising/lowering unit 47 is made to enter the standby state (STEP 207).

In the above described process, also the inside of the bellows unit 45 in the negative pressure adjustment mechanism 44 is communicated with the air via the lower tank air chamber 24 when the air release valve 26 is opened in STEP 205. Accordingly, the bellows unit 45 is stretched out by the weight of the weight unit 46 to the position supported by the bellows raising/lowering unit 47 that is positioned below.

By moving the bellows raising/lowering unit 47 to the standby position in STEP 207, the ink circulation operation can be performed in a short time when the next printing operation is performed.

When the bellows raising/lowering unit 47 is moved to the standby position, the bellows unit 45 is contracted. If this operation is performed in the state where the air release valve 26 is not released, the internal pressure of the lower tank 7 fluctuates. Therefore, a waiting time until the air release value is completely opened is required. This waiting time is that referred to in STEP 206.

As described above, this embodiment can provide the ink filling processing method for stably filling the ink heads with ink that does not contain the air or air bubbles when the ink circulating unit 4 is filled with the ink.

This embodiment refers to the inkjet printer adopting the line head. However, this embodiment is also applicable to an inkjet printer adopting a serial head.

### First Modification Example of the First Embodiment

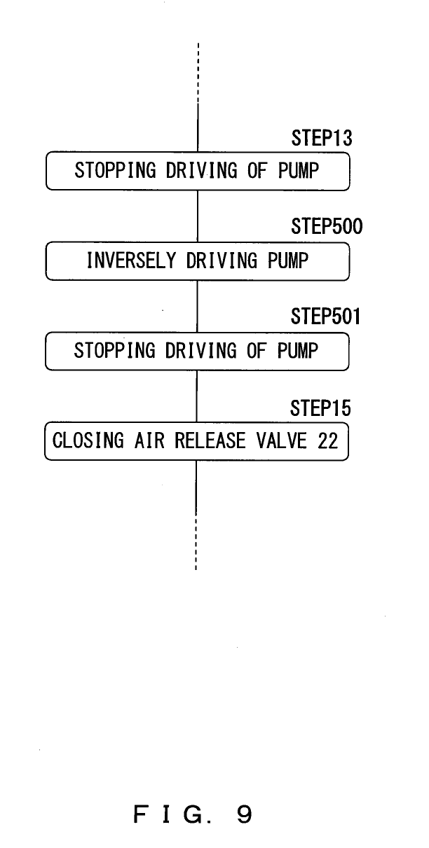

FIG. 9 is a flowchart for explaining a first modification example of the above described ink filling process in the first embodiment.

In the first modification example, the setting of the waiting time in STEP 14 of the flowchart illustrated in FIG. 4 is replaced with a process for inversely driving the pump 11 in STEP 500, and a process for stopping the driving of the pump in STEP 501. The other steps are similar to those of the flowchart illustrated in FIG. 4.

In this process, the pump 11 is used as means for securing the amount of ink flowing down from the upper tank 6 into the lower tank 7. By inversely rotating the pump 11, the ink of the upper tank 6 can be conveyed to the lower tank 7.

As described above, according to the first modification example of the first embodiment, the ink of the upper tank 6 can be conveyed to the lower tank 7 in a short time by inversely rotating the pump 11. As a result, the ink filling process can be shortened.

As a matter of course, effects similar to those of the first embodiment can be obtained according to this first modification example.

### Second Modification Example of the First Embodiment

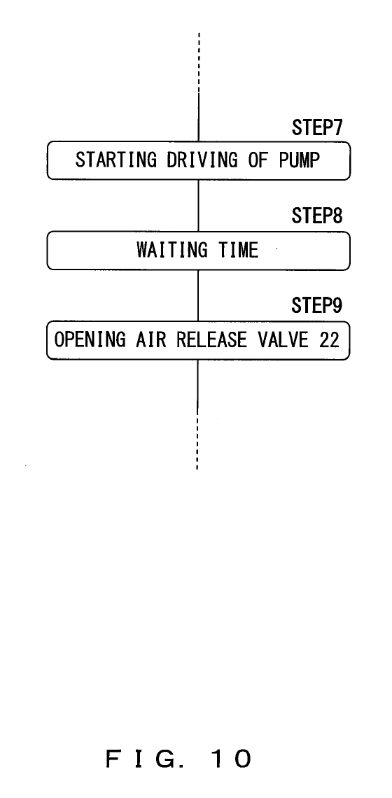

FIG. 10 is a flowchart for explaining a second modification example of the process for filling the ink circulating unit 4 with ink in the first embodiment.

The ink filling process referred to in the second modification example is a process executed in the case of refilling the inkjet printer where the ink circulating unit 4 is once filled with the ink. This case is, for example, a case of replacing some of the plurality of ink heads. In such a case, the amount of ink remaining in the ink circulating unit 4 is unknown.

Therefore, in the second modification example, as illustrated in FIG. 10, a process of STEP 8 is interposed between STEP 7 and STEP 9 of the flowchart illustrated in FIG. 4. The other steps are similar to those of the flowchart illustrated in FIG. 4.

In the process of STEP 8, a predetermined amount of time is waited until the air release valve 22 is opened (STEP 9) after the pump 11 is driven (STEP 7). The reason why the predetermined amount of time is waited is to prevent the ink from overflowing from the upper tank 6.

Namely, when the ink is refilled, the amount of ink remaining in the ink circulating unit 4 is unknown. For example, if the air release valve 22 is opened (STEP 9) immediately after the pump 11 is driven (STEP 7) in the state where a sufficient amount of ink remains in the upper tank 6 or the lower tank 7, the ink conveyed from the lower tank 7 makes the upper tank 6 overflow.

Accordingly, the waiting time is set (STEP 8) after the pump is driven (STEP 7), and the air release valve 22 is kept closed also after the pump 11 is driven as in the second modification example, thereby preventing the upper tank 6 from overflowing.

Specifically, the pressure within the upper tank 6 rises if the ink is conveyed by the pump 11 to the upper tank 6. This is because the upper tank 6 is blocked from the air.

As a result, the ink of the upper tank 6 can be rapidly reduced. Accordingly, the upper tank 6 can be prevented from overflowing. As described above, the waiting time in STEP 8 is set to a time during which the upper tank 6 does not overflow.

Subsequent to the time waiting process in STEP 8, the air release valve 22 is released (STEP 9).

Because subsequent processes are the same as those of FIG. 4, their descriptions are omitted.

Also in the second modification example, effects similar to those of the first embodiment can be obtained as a matter of course.

### Third Modification Example of the First Embodiment

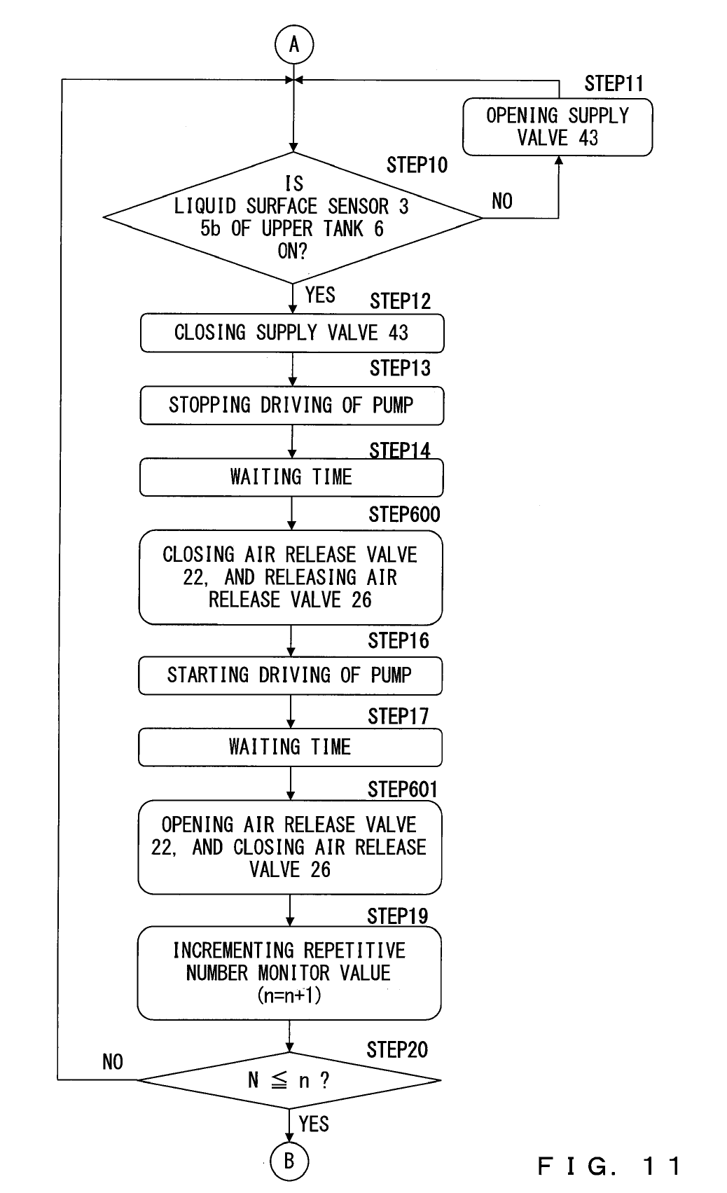

FIG. 11 is a flowchart for explaining a third modification example of a process for filling the ink circulating unit with ink in the first embodiment. In the third modification example, only the processes of STEP 15 and STEP 18 in the ink filling process in the first embodiment represented by the flowchart illustrated in FIG. 4 are different.

Namely, in the third modification example, the air release valve 22 is closed and the air release valve 26 is released in STEP 600 subsequent to STEP 14. Moreover, in STEP 601 subsequent to STEP 17, the air release valve 22 is released and the air release valve 26 is closed.

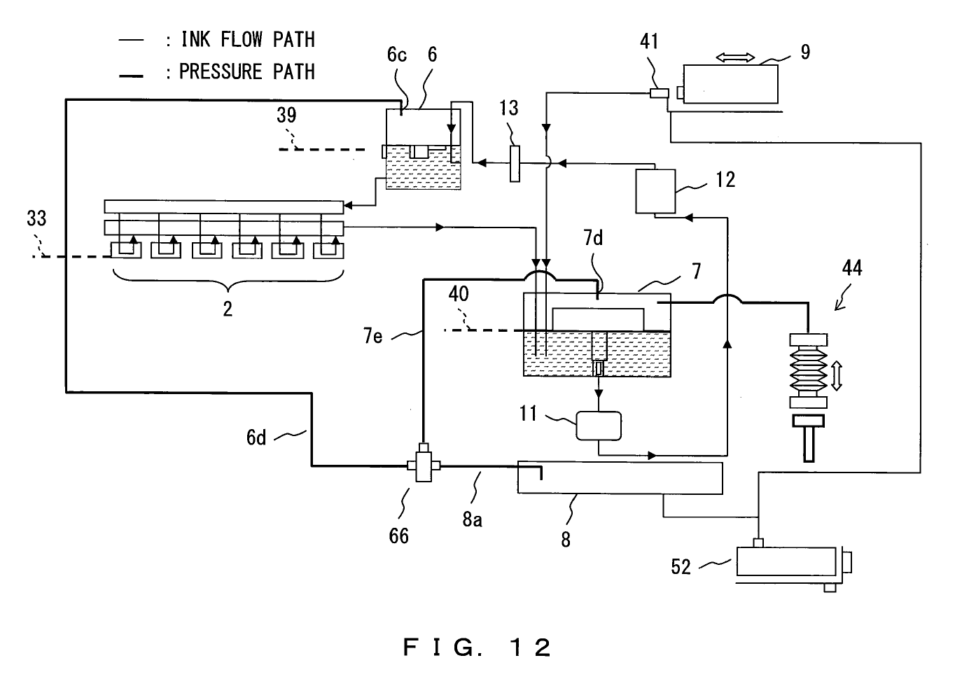

FIG. 12 schematically illustrates a configuration of ink paths of the inkjet printer according to the third modification example.

As illustrated in FIG. 12, a three-directional electromagnetic valve 66, to which a tube 6d extending from the air port 6c of the upper tank 6, a tube 7e extending from the air port 7d of the lower tank 7, and a tube 8a extending from the overflow tank 8 are connected, is arranged.

The three-directional electromagnetic valve 66 blocks the tube 7e of the lower tank 7 from the tube 8a of the overflow tank 8 simultaneously when communicating the tube 6d of the upper tank 6 with the tube 8a of the overflow tank 8.

Additionally, the three-directional magnetic valve 66 communicates the tube 7e of the lower tank 7 with the tube 8a of the overflow tank 8 simultaneously when blocking the tube 6d of the upper tank 6 from the tube 8a of the overflow tank 8.

Accordingly, even if the above described two air release valves such as the air release valve 22 of the upper tank 6 and the air release valve 26 of the lower tank 7, which are illustrated in FIG. 2, are replaced with the above described three-directional electromagnetic valve 66, a control similar to that referred to in the first embodiment, and its first and second modification examples can be performed.

### Second Embodiment

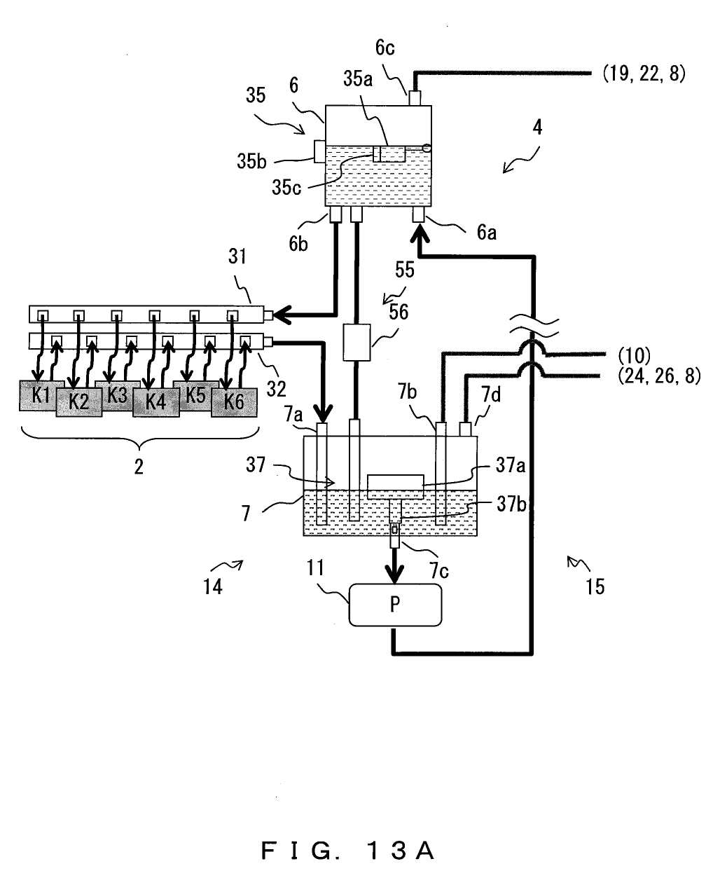

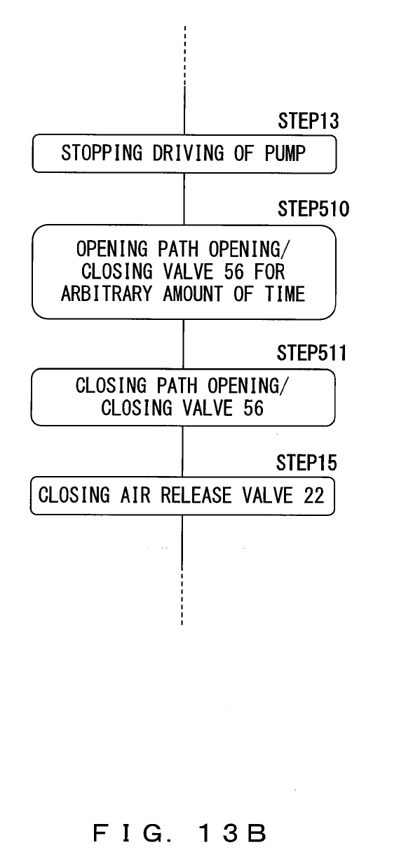

FIG. 13A illustrates an ink circulating unit 4 in a second embodiment. FIG. 13B is a flowchart illustrating a process for controlling the ink circulating unit 4. The same components as those of FIGS. 2 and 3 are denoted with the same reference numerals as those of FIGS. 2 and 3.

In the second embodiment, the ink circulating unit 4 is configured by providing a third ink path 55 between the upper tank 6 and the lower tank 7 as illustrated in FIG. 13A in addition to the first ink path 14 and the second ink path 15 in the configuration of the ink circulating unit 4 in the first embodiment illustrated in FIG. 3.

The third ink path 55 is provided with a path opening/closing valve 56 that can open/close this ink path. By releasing the path opening/closing valve 56, the ink of the upper tank 6 can be directly conveyed to the lower tank 7 through the third ink path 55.

Moreover, in an ink filling process in the second embodiment, the process for setting the waiting time in STEP 14 of the flowchart in the first embodiment, which is illustrated in FIG. 4, is replaced with a process for opening the path opening/closing valve 56 for an arbitrary amount of time (STEP 510), and a process for closing the path opening/closing valve 56 (STEP 511), as illustrated in FIG. 13B. The other steps are similar to those of FIG. 4.

According to the second embodiment, the ink of the upper tank 6 can be conveyed to the lower tank 7 through the third ink path 55 in a short time, whereby the ink filling time can be reduced.

Additionally, effects similar to those of the first embodiment can be obtained.

### Third Embodiment

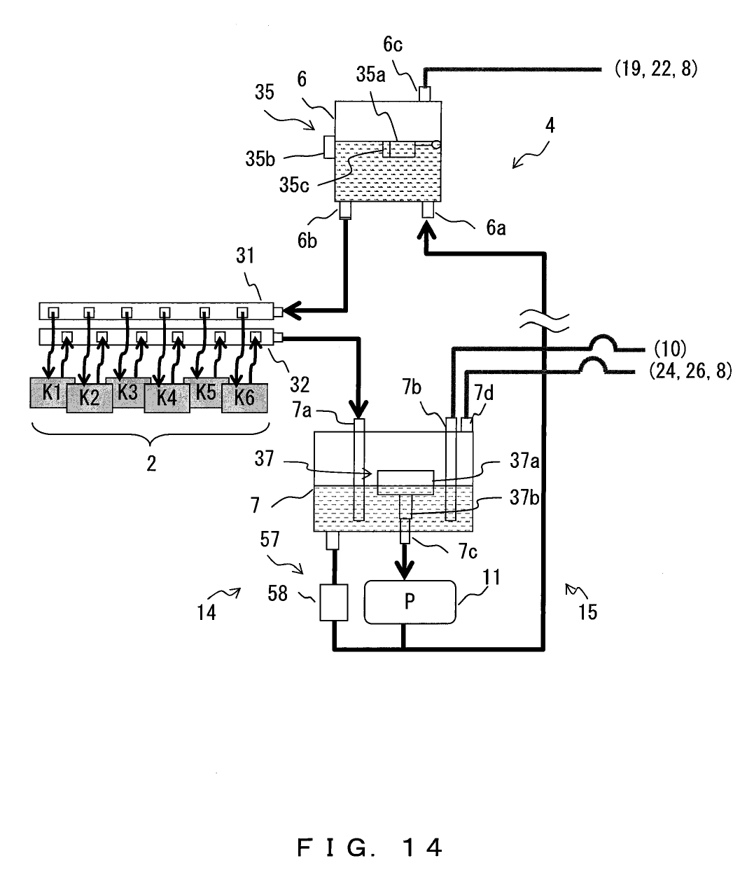

FIG. 14 illustrates an ink circulating unit 4 in a third embodiment. In FIG. 14, the same components as those of FIG. 3 are denoted with the same reference numerals as those of FIG. 3.

In the third embodiment, a third ink path 57 that bypasses the pump 11, and a path opening/closing valve 58 are provided as illustrated in FIG. 14.

Additionally, in an ink filling process in the third embodiment, the process for setting the waiting time in STEP of the flowchart in the first embodiment, which is illustrated in FIG. 4, is replaced with a process for opening the path opening/closing valve 58 for an arbitrary amount of time, and a process for closing the path opening/closing valve 58. The other steps are the same as those of FIG. 4.

Also in the third embodiment, the path opening/closing valve 58 is opened when the air within the upper tank 6 is released and the pump 11 is stopped. As a result, the ink of the upper tank 6 can be directly conveyed to the lower tank 7.

According to the third embodiment, the ink of the upper tank 6 can be conveyed to the lower tank 7 through the third ink path 57 in a short time, whereby the ink filling time can be reduced.

### Fourth Embodiment

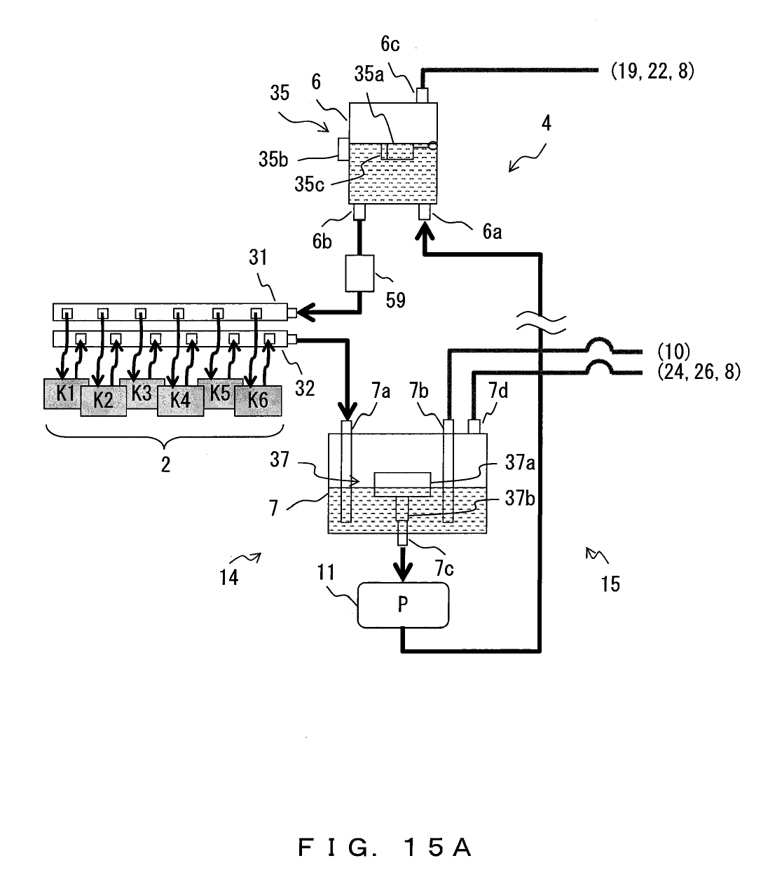

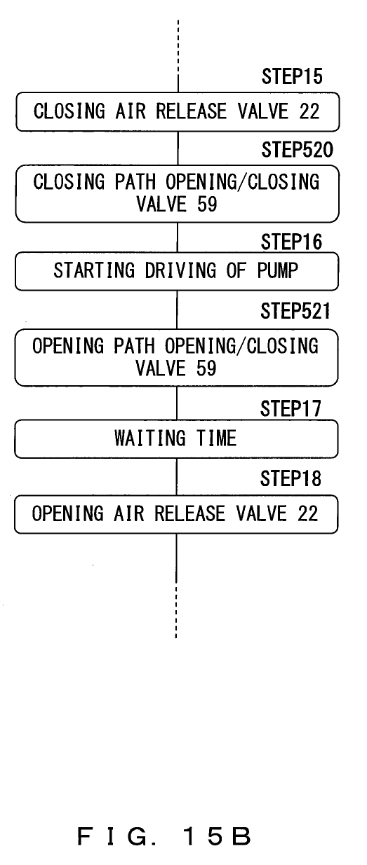

FIG. 15A illustrates an ink circulating unit 4 in a fourth embodiment. FIG. 15B is a flowchart illustrating a process for controlling this ink circulating unit 4. In FIG. 15A, the same components as those of FIGS. 2 and 3 are denoted with the same reference numerals as those of FIGS. 2 and 3.

In the fourth embodiment, the ink circulating unit 4 is configured by providing a path opening/closing valve 59 on an ink path connecting the upper tank 6 and the ink distributor 31 as illustrated in FIG. 15A in the configuration of the ink circulating unit 4 in the first embodiment, which is illustrated in FIG. 3.

Additionally, in an ink filling process in the fourth embodiment, a process for closing the path opening/closing valve 59 (STEP 520), and a process for opening the path opening/closing valve 59 (STEP 521) are additionally interposed between the processes of STEP 15 and STEP 16 and between the processes of STEP 16 and STEP 17, respectively in the flowchart in the first embodiment, which is illustrated in FIG. 4.

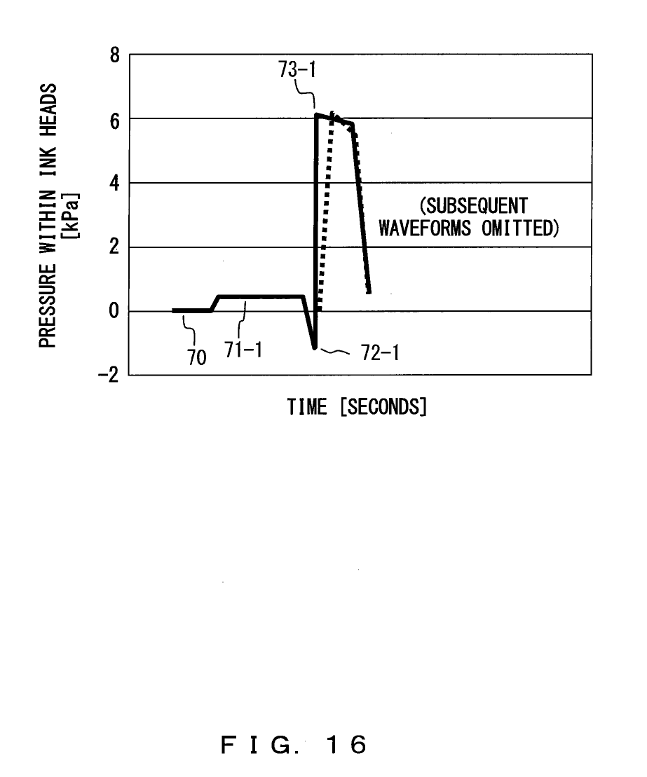

FIG. 16 illustrates fluctuations in the pressure within the ink heads (K1 to K6) in the ink filling process illustrated in FIG. 15B in the fourth embodiment.

In the ink filling process illustrated in FIG. 15B in the configuration according to the fourth embodiment, the path opening/closing valve 59 is closed (STEP 520) after the air release valve 22 is closed (STEP 15). By driving the pump 11 (STEP 16), the internal pressure of the upper tank 6 rapidly rises.

By opening the path opening/closing valve 59 in this state (STEP 521), the ink is conveyed to the ink heads (K1 to K6) with high pressure. The other processes are similar to those of FIG. 4.

The rising waveform of the waveform 73-1 that appears as the pressure within the ink heads (k1 to K6) in the first embodiment, which is illustrated in FIG. 6, has an inclination as indicated by a broken line in FIG. 16 due to the influence of the ink flowing out of the first ink path 14. In the fourth embodiment, however, the internal pressure of the ink heads (K1 to K6) rapidly rises as indicated by a solid line in FIG. 16.

As described above, according to the fourth embodiment, a rapid pressure change can be made to occur in the ink heads (K1 to K6), whereby more stable ink filling can be made.

The present invention is not limited to the above described embodiments and their modification examples. Practically, the present invention can be modified in a variety of ways within a scope that does not depart from the gist of the present invention.

What is claimed is:

1. An ink filing method for filling a plurality of ink heads of an inkjet printer having an ink circulating unit including the plurality of ink heads for spraying ink, a first tank, which is arranged upper than the plurality of ink heads in a gravitational direction, for storing the ink to be supplied to the plurality of ink heads, a second tank, which is arranged lower than the plurality of ink heads in the gravitational direction, for storing the ink not sprayed by the plurality of ink heads, and a pump for conveying the ink within the second tank to the first tank, comprising:
a first step of driving the pump for a predetermined amount of time in a state where the first tank is sealed; and
a second step of stopping the pump for a predetermined amount of time in a state where air within the first tank is released.

2. The ink filling method according to claim 1, wherein
the first step and the second step are repeatedly executed by a plurality of times.

3. The ink filling method according to claim 1, further comprising
a waiting step of stopping the pump in a state where the first tank is sealed, and of waiting for a predetermined amount of time between the first step and the second step.

4. The ink filling method according to claim 2, further comprising
a waiting step of stopping the pump in a state where the first tank is sealed, and of waiting for a predetermined amount of time between the first step and the second step.

5. The ink filling method according to claim 1, wherein
air within the second tank is released in the first step and the second step.

6. The ink filling method according to claim 4, wherein
air within the second tank is released in the first step and the second step.

7. The ink filling method according to claim 1, wherein
air within the second tank is released in the first step, and the second tank is sealed in the second step.

8. The ink filling method according to claim 4, wherein
air within the second tank is released in the first step, and the second tank is sealed in the second step.

9. The ink filling method according to claim 1, wherein
the pump is inversely driven to convey the ink within the first tank to the second tank in the second step.

10. The ink filling method according to claim 1, wherein
the ink circulating unit further comprises a connection path, which includes a path opening/closing valve, for connecting the first tank and the second tank,
the path opening/closing valve on the connection path is kept closed in the first step, and
the path opening/closing valve on the connection path is kept released in the second step.

11. The ink filling method according to claim 1, wherein
the ink circulating unit further comprises a path opening/closing valve on a path from the first tank to the ink head,
the path opening/closing valve is released after being kept closed for a predetermined amount of time in the first step, and
the path opening/closing valve is kept released in the second step.

12. An ink filling method for filling an ink head of an inkjet printer having an ink circulating unit including the ink head for spraying ink, a first tank, which is arranged upper than the ink head in a gravitational direction, for storing the ink to be supplied to the ink head, a second tank, which is arranged lower than the ink head in the gravitational direction, for storing the ink not sprayed by the ink head, and a pump for conveying the ink within the second tank to the first tank, comprising:
a first step of driving the pump for a predetermined amount of time in a state where the first tank is sealed; and
a second step of stopping the pump for a predetermined amount of time in a state where air within the first tank is released.

13. An inkjet printer, comprising:
an ink circulating unit including
an ink head having a nozzle plate on which a plurality of nozzles for spraying ink are formed,
a first tank, which is arranged upper than the nozzle plate in a gravitational direction, for storing the ink to be supplied to the ink head,
a first air release valve, which can be opened/closed, for making the first tank enter a sealed state or an air released state,
a second tank, which is arranged lower than the nozzle plate in the gravitational direction, for storing the ink not sprayed from the ink head, and
a pump for conveying the ink within the second tank to the first tank; and
a controlling unit for controlling opening/closing of the first air release valve and driving of the pump when the ink head is initially filled with the ink, wherein
the controlling unit repeatedly performs, by a plurality of times, a control for driving the pump for a predetermined amount of time in a state where the first air release valve is closed, and a control for stopping the pump for a predetermined amount of time in a state where the first air release valve is released.

14. The inkjet printer according to claim 13, wherein
the second tank further includes a second air release valve, which can be opened/closed, for making the second tank enter a sealed state or an air released state, and
the controlling unit continuously releases the second air release valve.

15. The inkjet printer according to claim 13, wherein
the second tank further includes a second air release valve, which can be opened/closed, for making the second tank enter a sealed state or an air released state, and
the controlling unit releases the second air release valve when closing the first air release valve, and closes the second air release valve when releasing the first air release valve.

16. The inkjet printer according to claim 13, wherein
the controlling unit inversely drives the pump to convey the ink within the first tank to the second tank when performing the control for stopping the pump for the predetermined amount of time in the state where the first air release valve is released.

17. The inkjet printer according to claim 13, wherein
the ink circulating unit further comprises a connection path, which includes a path opening/closing valve, for connecting the first tank and the second tank, and
the controlling unit closes the path opening/closing valve when closing the first air release valve, and releases the path opening/closing valve when releasing the first air release valve.

18. The inkjet printer according to claim 13, wherein
the ink circulating unit further comprises a path opening/closing valve on a path from the first tank to the ink head, and
the controlling unit keeps the path opening/closing valve closed for a predetermined amount of time when closing the first air release valve, and releases the path opening/closing valve after the predetermined amount of time elapses, or keeps the path opening/closing valve open when releasing the first air release valve.
